(19) United States
(12) Patent Application Publication
(10) Pub. No.: US 2001/0035370 A1
(43) Pub. Date: Nov. 1, 2001

(54) Method of automatic sexing of chicks

(76) Inventors: Amotz Yavnai, Kiryat Motzkin (IL); Sharon Ehrlich, Moshav Beit Herut (IL)

Correspondence Address: DR. MARK FRIEDMAN LTD., C/O Anthony Castorina, Suite 207, 2001 Jefferson Davis Highway, Arlington, VA, 22202, US

(21) Appl. No.: 09/852,666

(22) Filed: May 11, 2001

Related U.S. Application Data
(62) Division of application No. 09/416,262, filed on Oct. 12, 1999.

(51) Int. Cl. B65G 21/10

(52) U.S. Cl. 209/3; 198/631.1; 198/836.1

(57) ABSTRACT

A method and apparati of automatic sexing of a one-day-old chick which includes inducing the chick to lose its equilibrium and voluntarily spread its wings. An example of an apparatus which causes chick disequilibrium includes a cup with a rim, a funnel removably seated on the rim, and a free-rolling ball inside the cup. A second example of such an apparatus includes a conveyer belt, a mechanical vibrator attached to the surface of the conveyer belt, and two poles for supporting the spread wings. A third example of such an apparatus includes a passageway enclosed on both sides whose bottom is attached to an oscillator. The wings are caused to be spread so that chick sexing can be performed by photographing the chick, applying appropriate image processing to the photograph, identifying the sex of the chick from the processed photograph, weighing the chick, and processing chicks based on sex and weight. Preferably, the chick is photographed in blue light, using a digital camera.

This is a Divisional of pending U.S. patent application Ser. No. 09/416,262 filed Oct. 12, 1999.

### FIELD AND BACKGROUND OF THE INVENTION

The present invention relates to a method of chick sexing of a one-day-old chick, and, more particularly, to a method of causing a chick's wings to spread automatically for a sufficient length of time so that chick sexing can be performed.

In egg-laying chicks, early determination of a chick's sex is essential for correct processing. In broiler chicks, processing based on sex is also desirable. The wing feathers vary between males and females. Therefore examination of the tips of the wings provides a means of sex identification.

Various attempts have been made to determine the sex of the chick. Most prior art specifies manual methods. These methods are labor intensive, require significant training, and are prone to human error. Although prior art recognizes that the inspection of chicks provide the sex of the chick, for example U.S. Pat. No. 3,704,688 dated Dec. 5, 1972, no explanation is given on how the spreading of the wings takes place. Suzuki (U.S. Pat. No. 4,417,663 dated Nov. 29, 1983) describes an automated method of determining the sex of a chick through the examination of the anal region. However, sex determination based on wing tips is not included.

There is thus a widely recognized need for, and it would be highly advantageous to have a way to automate the spreading of the chicks' wings, which in turn would allow a fully automated sex identification and sorting process based on the examination of wing tips.

### SUMMARY OF THE INVENTION

According to the present invention there is provided a method of sexing a chick including the step of: (a) causing the chick to lose equilibrium, thereby voluntarily spreading its wings; (b) shining a light on at least one spread wing; and (c) photographing at least one spread wing;

The invention preferably includes the further steps of:

(d) inferring the chick's sex from the photograph;

(e) weighing the chick; and

(f) processing the chick based on sex and weight.

The method of the present invention is a major advance towards the goal of efficient chick sexing. By causing a chick is to spread its wings automatically, rather than having its wings spread open manually, labor requirements are reduced. The chick sexing process can then be fully automated, eliminating the reliance on the skill of a human sex checker, and enabling consistent quality. In addition, the process can be carried out at a constant rate, uninterrupted, for 24 hours each day. The procedure for handling chicks of unidentifiable sex, minimizes the negative consequences of incorrect sex sorting, thereby maintaining the integrity of the sexing process.

Disequilibrium can result from certain actions, including but not limited to, removing a chick's foot support, placing the chick on a moving, vibrating, or unstable surface, causing the chick to jump, shaking the chick, shocking the chick with an electric voltage or acoustic noise, and warming the chick.

An example of an apparatus which causes chick disequilibrium includes: (a) a cup having a rim; (b) a funnel removably seated on the rim; and (c) a ball inside the rim and free to roll inside the cup.

A second example of an apparatus used to cause a chick to lose equilibrium and spread its wings includes: (a) a conveyer belt for transporting the chick in a certain direction; (b) a mechanical vibrator for vibrating a surface of the conveyer belt whereon the chick stands; and (c) two poles substantially parallel to the direction, for supporting the spread wings.

Preferably, the poles in the second apparatus are sloped relative to the conveyer belt.

A third example of an apparatus used to cause a chick to lose equilibrium and spread its wings, includes: (a) a bottom surface whereon the chick stands; (b) a mechanism for oscillating the bottom surface; and (c) two side surfaces attached to the bottom surface for supporting the spread wings.

Although the scope of the present invention includes the use of any light for illuminating the wing, the preferred color is blue, to enhance the contrast between the white wing tips and yellow body of a chick.

Although the scope of the present invention includes the use of any camera, the preferred camera is digital.

The present invention successfully addresses the shortcomings of the presently known configurations by providing a means to permit full automation of chick sexing based on wing feather patterns.

### BRIEF DESCRIPTION OF THE DRAWINGS

The invention is herein described, by way of example only, with reference to the accompanying drawings, wherein:

FIG. 1 is a pair of photographs of typical male and female chicks' wing feather patterns;

FIG. 2 is a flow chart of an automated sex identification and sorting process based on wing feather patterns;

FIG. 3 is a schematic top plan view of the chick processing system;

FIG. 4 is an illustration of causing chick disequilibrium by removing the chick's foot support;

FIG. 5 is an illustration of front and side views of a conveyer belt used in causing chick disequilibrium;

FIG. 6 is an illustration of front and side views of a passageway used in causing chick disequilibrium;

FIG. 7 is an illustration of causing chick disequilibrium by electric shock;

FIG. 8 is an illustration of causing chick disequilibrium by acoustic shock.

FIG. 9 is an illustration of causing chick disequilibrium by heat.

### DESCRIPTION OF THE PREFERRED EMBODIMENTS

The present invention is of an automatic means of causing a chick to spread its wings due to its loss of equilibrium, thereby exposing its tip wing feathers. Specifically, the present invention can be used as part of a fully automated chick sex screening process for one-day-old chicks, reducing training, labor requirements and the impact of human error, while enhancing efficiency, throughput, and quality consistency.

The principles and operation of a mechanism to automatically induce the spreading of a chick's wings according to the present invention may be better understood with reference to the drawings and the accompanying description.

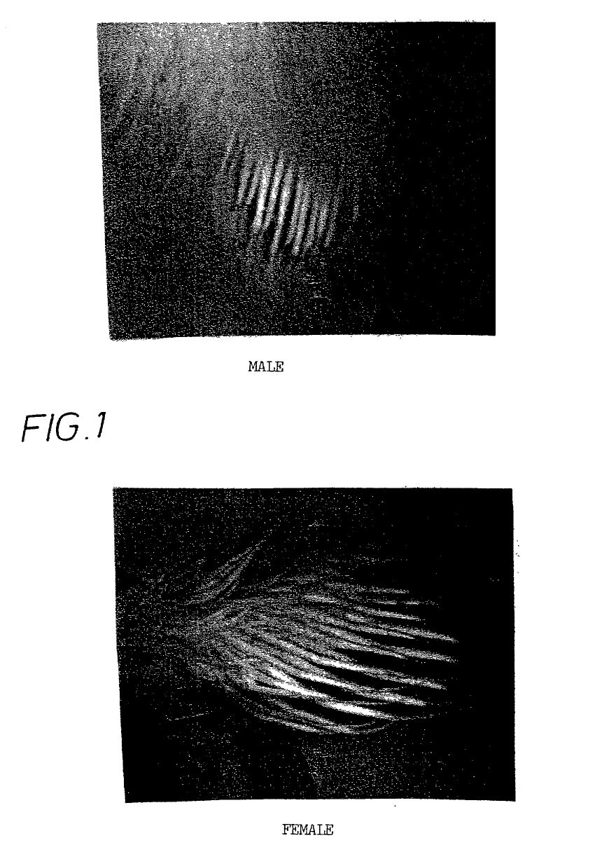

Referring now to the drawings, FIG. 1 illustrates the typical male and female patterns of wing feathers. It is apparent that wing feathers' makeup constitutes a sex-distinguishable characteristic among chicks.

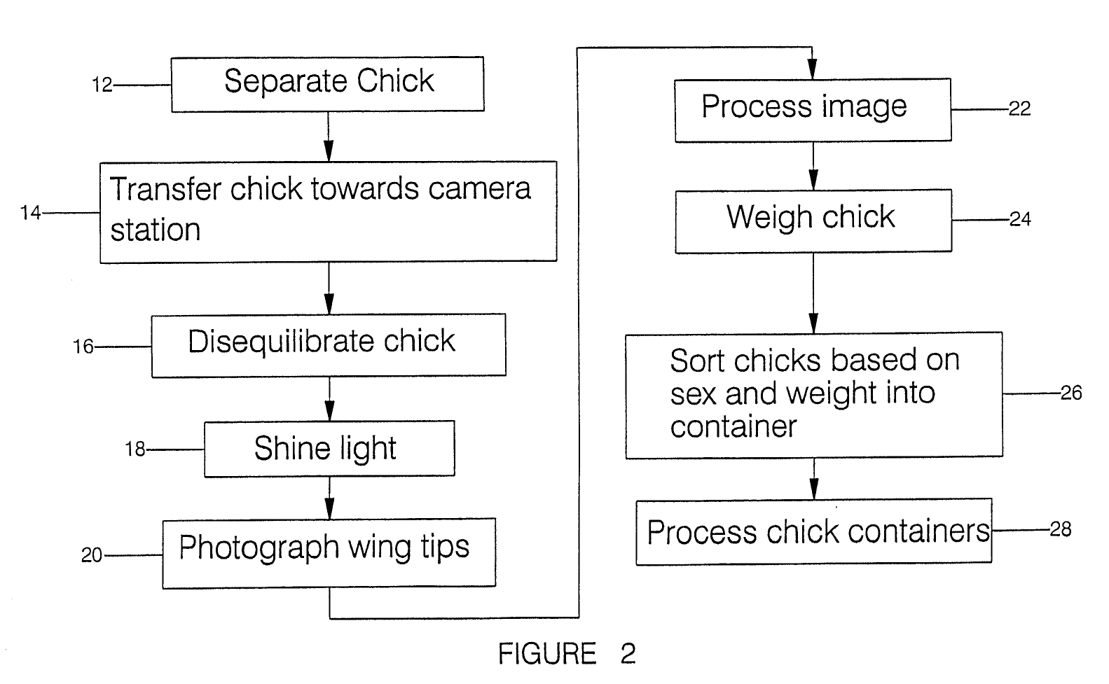

A flow chart of a fully automated process of sex identification and sorting is shown in FIG. 2. A chick is separated from the other chicks (box 12) and transferred by conveyer towards the camera station (box 14). A mechanism to cause disequilibrium of the chick is applied (box 16), prompting the chick to spread its wings and hold the position long enough for a photograph to be taken.

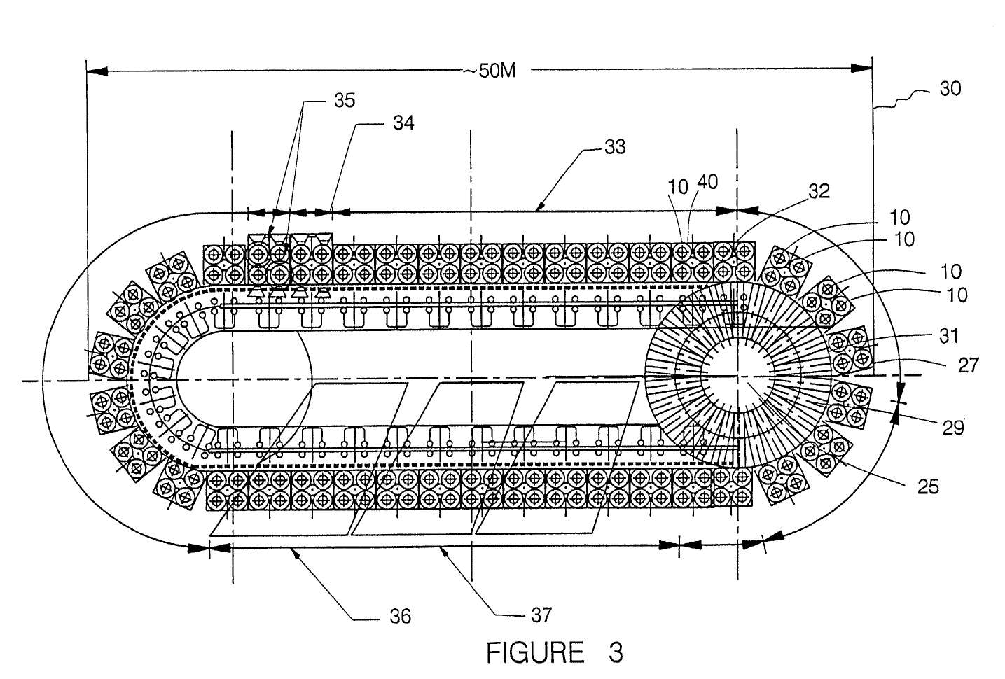

FIG. 3 shows a schematic plan of one type of a chick processing system 30 of the present invention. A round carousel 31 on the right of system 30 is bounded by an endless chain 32. Endless chain 32 contains a straight section 33 leading to the disequilibrium point 34 and to one or more camera stations 35, of which two are shown in FIG. 3. On the other side of camera stations 35, endless chain 32 curves around and loops back to carousel 31.

Carousel 31 with one or more channels 29 spins around. Chicks 10 are placed in center 25 of carousel 31, slip into channels 29, and at the appropriate moment, one or more chicks 10 are deposited into one or more cups 40. In FIG. 3, four cups 40 are shown connected together to form one unit 27. Units 27 of chicks 10 are transported by endless chain 32 towards disequilibrium point 34 where chicks 10 are caused to lose their equilibrium and to two camera stations 35 where photographs are taken simultaneously of two chicks 10. Straight section 33 prevents centrifugal forces from acting on chicks 10 prior to the picture taking. Endless chain 32 continues to transport units 27 of chicks 10 to the weighing station 36 and the sorting area 37.

Chick disequilibrium can be caused by any number of methods, including but not limited to: removing the chick's foot support, placing the chick on a moving, vibrating, or unstable surface, inducing the chick to jump, shaking the chick, shocking the chick with an electric voltage or acoustic noise, and warming the chick.

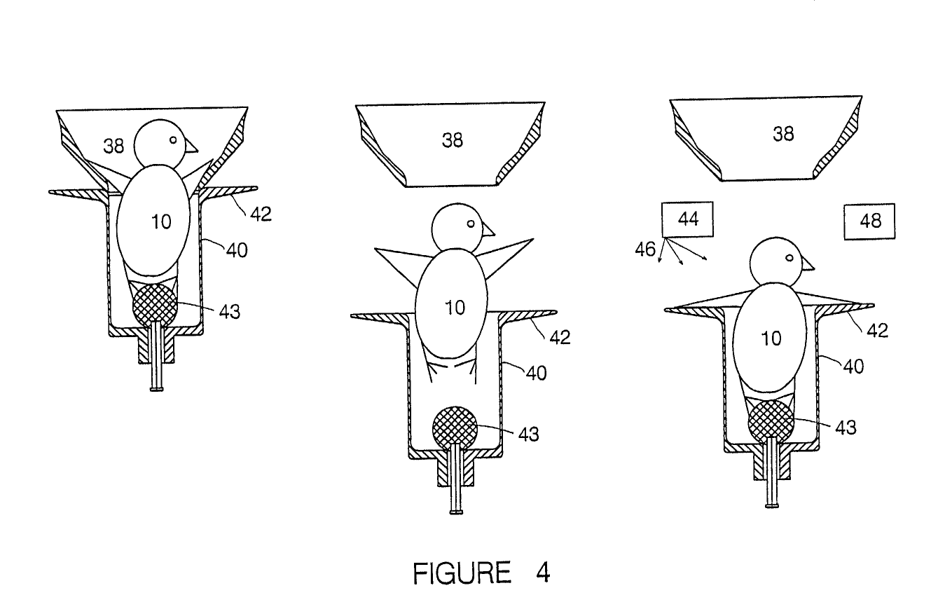

FIG. 4 illustrates an example of a method of causing chick disequilibrium by placing chick 10 on an unstable surface and then completely removing foot support. Chick 10 is dropped into a funnel 38 which sits on cup 40 whose upper edge 42 extends outwards. Note that cup 40 is the cup that is transported by endless chain 32 in FIG. 3. Chick 10, while in cup 40 stands on a free-moving ball 43. When cup 40 is lowered, foot support is removed from chick 10. Chick 10, therefore, loses its equilibrium, spreads its wings, and falls back into the cup. The wings of chick 10 remain spread out on edge 42.

At each camera station 35, light source 44 shines light 46 on chick 10 whose wings are spread (box 18 in FIG. 2). Preferably, light source 44 radiates a blue monochromatic light to enhance the contrast between chick 10's white wing tips and yellow body. A preferred example of light source 44 is a light emitting diode with a visible spectrum centered around 470 nm. A camera 48, preferably digital, takes one picture of the spread wing tips of chick 10 at a shutter speed of, for example, 1/10,000 (box 20 in FIG. 2).

The image taken by camera 48 is processed and sex identification is attempted based on the sex distinguishable wing feather patterns. (FIG. 2, box 22). There are three possible outcomes of the sex identification process. First, chick 10 is identified as male. Second, chick 10 is identified as female. Third, the sex of chick 10 is unidentifiable. The sex may be unidentifiable due to either a genetic problem or because the wings were not spread.

Chick 10 is removed from camera station 35, weighed at weighing station 36 (box 24), counted and routed to the correct chick container based on its sex and weight at sorting area 37 (box 26 in FIG. 2). Chick 10 is released into the correct container either by overturning cup 40 or opening the bottom of cup 40. In the case of egg laying chicks 10, male and unidentified chicks 10 are separated from female chicks 10. In the case of broiler chicks 10, separate containers are established for male, female and unidentified chicks 10. If the sex of a significant number of chicks 10 was not identified, this batch of unidentified chicks 10 could be re-sexed. Once a chick container is filled, it is processed based on its ultimate destination (FIG. 2 box 28).

It should be apparent to those skilled in the art that multiple chicks 10 can be processed simultaneously, provided more than one station of identical purpose is available.

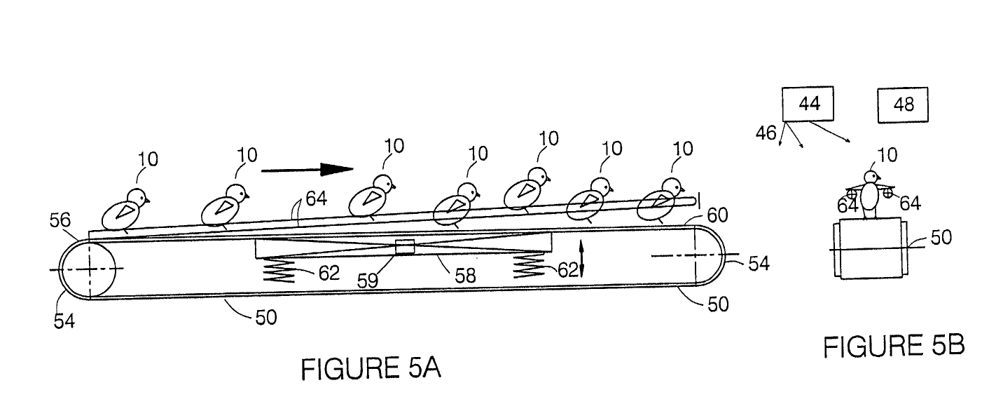

Another possible method of causing chick disequilibrium is shown in FIG. 5. A conveyer belt 50 includes an endless belt 52 supported and moved by rollers 54 in the conventional manner. A chick 10 is placed on the left end 56 of conveyer belt 50. Rollers 54 rotate clockwise, to move the upper surface of endless belt 52 rightward, thereby transporting chick 10 rightward. A mechanical vibrator 58 attached to the upper surface 60 of conveyer belt 50 contains a number of springs 62, of which two are shown in FIG. 5. Mechanical vibrator 58 includes an electric motor 59 which rotates causing springs 62 to move up and down, and upper surface 60 to vibrate up and down. Two poles 64, parallel to conveyer belt 50, extend along the length of conveyer belt 50 sloping upwards to the right. Due to the vibrating motion of upper surface 60, chick 10 loses its equilibrium, jumps up and spreads its wings. Chicks 10 that have jumped up are shown in phantom. Poles 64 support the spread wings while light 46 shines on the wing tips of chick 10 and camera 48 photographs the wings tips of chick 10. Note that the characteristics of light 46 and camera 48 were described above.

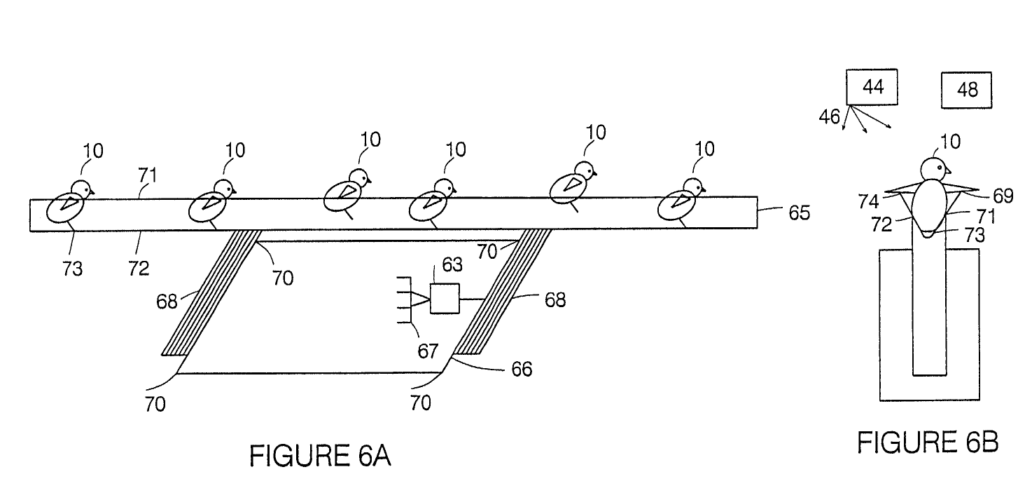

FIG. 6 shows an alternative method of causing chick disequilibrium. An oscillator 66 includes one or more springs 67 and a pneumatic piston or electromagnetic device 63. Oscillator 66 is attached to a bottom surface 73 on which chick 10 stands. Side surfaces 71 and 72 are connected to bottom surface 73. It should be apparent that a passageway 65 through which chicks 10 can move is composed of surfaces 73, 72, and 71. The two parallel sides 68 of oscillator 66 sway right and left in tandem about their pivots 70, causing bottom surface 73 and side surfaces 71 and 72 to move right and left. The movement of parallel sides 68 and therefore also of surfaces 73, 71, and 72 is faster to the right than to the left. Due to the movement of surfaces 73, 71, and 72, chick 10 jumps up, spreads its wings and land more rightward on bottom surface 73. Chicks 10 that have jumped up are shown in phantom The top edges 69 and 74 of surfaces 71 and 72 support the spread wings of chick 10 while light 46 shines on the wing tips of chick 10 and camera 48 photographs the wings tips of chick 10. Note that the characteristics of light 46 and camera 48 were described above.

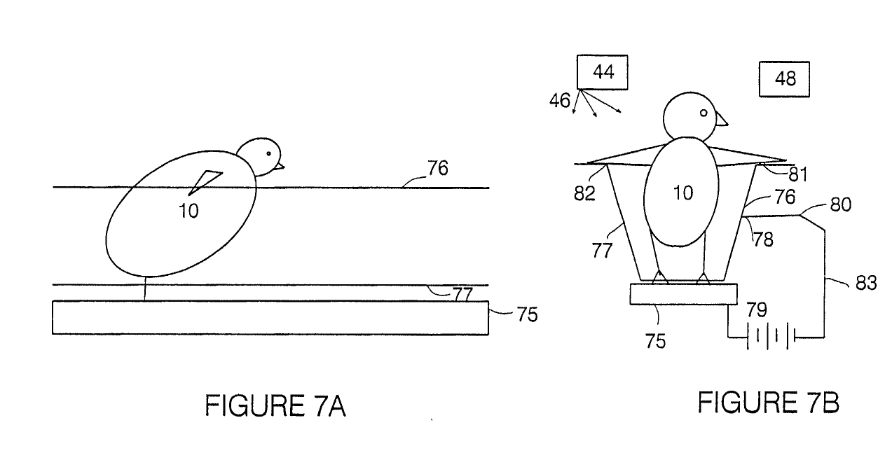

An alternative method of causing chick disequilibrium is shown in FIG. 7. A chick 10 is connected to a source of electric voltage 80. Chick 10 stands on an electrically conducting surface 75. Chick 10 is bounded on two sides by electrically conducting surfaces 76 and 77. Note that surface 75 is insulated from surfaces 76 and 77. The negative potential 78 of an electric voltage source 74 is connected to surface 76 and the positive potential 79 of electric voltage source 74 is connected to surface 75. Once a switch 83 is turned on, the electric shock causes chick 10 to lose its equilibrium, jump up and spread its wings. The top edges 81 and 82 of surfaces 76 and 77 support the spread wings of chick 10.

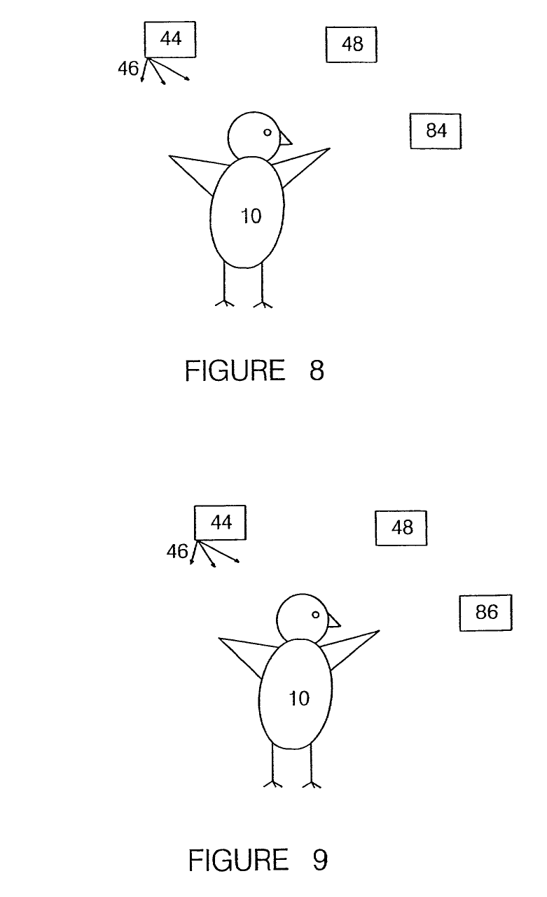

An alternative method of causing chick disequilibrium is illustrated in FIG. 8. FIG. 8 shows chick 10 moved into close proximity to a source of acoustic shock 84. The acoustic shock from source 84 causes chick 10 to lose its equilibrium and spread its wings.

FIG. 9 shows an alternative method of causing chick disequilibrium. FIG. 9 illustrates chick 10 moved into close proximity to a source of heat 86. The heat from source 86 causes chick 10 to lose its equilibrium and spread its wings. In each of these described methods, light 46 shines on the spread wing tips of chick 10 and camera 48 photographs the spread wings tips of chick 10. Note that the characteristics of light 46 and camera 48 were described above.

While the invention has been described with respect to a limited number of embodiments, it will be appreciated that many variations, modifications and other applications of the invention may be made.

What is claimed is:

1. An apparatus used to cause a chick to lose equilibrium and spread wings thereof, comprising:
(a) a conveyor belt for transporting the chick in a certain direction;
(b) a mechanical vibrator for vibrating a surface of the conveyor belt whereon the chick stands; and
(c) two poles substantially parallel to said direction, for supporting the spread wings.

2. The apparatus of claim 1, wherein said poles are sloped relative to said conveyor belt.

3. An apparatus used to cause a chick to lose equilibrium and spread wings thereof, comprising:
(a) a bottom surface whereon the chicks stand;
(b) a mechanism for oscillating said bottom surface; and
(c) two side surfaces attached to said bottom surface for supporting the spread wings.
